(19) United States
(12) Patent Application Publication
(10) Pub. No.: US 2024/0018043 A1
(43) Pub. Date: Jan. 18, 2024

(54) CONSTRUCTION MATERIALS PRODUCED USING WASTE VIA CARBON SEQUESTRATION

(71) Applicant: The Hong Kong University of Science and Technology, Hong Kong (CN)

(72) Inventors: Charles Wang Wai NG, Hong Kong (CN); Pui San SO, Hong Kong (CN); Sze Yu LAU, Hong Kong (CN); Poman LO, Hong Kong (CN)

(21) Appl. No.: 18/347,894

(22) Filed: Jul. 6, 2023

Related U.S. Application Data
(60) Provisional application No. 63/389,898, filed on Jul. 17, 2022.

(30) Foreign Application Priority Data
Jul. 3, 2023 (CN) 202310798408.7

(51) Int. Cl. C04B 18/30; C04B 18/02; C04B 18/167

(52) U.S. Cl. CPC C04B 18/30; C04B 18/021; C04B 18/167; C04B 2103/65

(57) ABSTRACT

Method for preparing a sustainable construction material, the method including: combining construction waste, food waste comprising calcium, and water thereby forming a waste mixture; optionally moulding the waste mixture; and contacting the waste mixture with CO₂ under conditions in which at least a portion of the calcium present in the waste mixture is converted to calcium carbonate thereby forming a treated waste mixture thereby forming the sustainable construction material.

### CROSS-REFERENCE TO RELATED APPLICATIONS

The present application claims priority from China Patent Application No. 202310798408.7, filed on Jul. 3, 2023, which claims priority from U.S. Provisional Patent Application No. 63/389,898, filed on Jul. 17, 2022, which are hereby incorporated by reference in their entirety.

### TECHNICAL FIELD

This disclosure relates to a method of producing sustainable construction materials and products thereof. More particularly, provided herein is a method of preparing sustainable construction materials from construction and food waste via the sequestration of CO₂.

### BACKGROUND

Climate change driven by global warming is becoming more severe and contributing to extreme weather events, threatening both human life and property. One of the main causes is believed to be excessive emissions of greenhouse gases, especially CO₂, due to the soaring global population and human activity. To alleviate global warming, most countries are committed to reducing, recycling, and reusing municipal solid waste (MSW) to facilitate carbon neutrality and achieve sustainable development.

The two major types of solid waste across the globe are construction and food waste. China produces nearly 2 billion tons of construction waste annually, which accounts for 40% of all MSW and is expected to continue growing at 10% per annum. Construction waste comprises around 15% of the annual MSW in the European Union and almost 70% of the annual MSW in the US. Global food waste is recorded to amount to about 1 billion tons per annum, constituting nearly 20% of global food production. Thus, methods to reduce and recycle such waste and even to turn it into valuable products are urgently needed to move society towards sustainability.

In addition to waste generation, the waste itself also leads to CO₂ emissions. Construction waste primarily consists of rubble, bricks, soil and concrete generated during work such as the construction and demolition of buildings, ground levelling and road paving. Cement is usually involved as a binder during the production of typical construction materials. The production of each ton of cement generates around one ton of CO₂, accounting for about 10% of global greenhouse gas emissions. The production of other construction materials, including clay brick, also requires high pressure compression and high temperature curing at over 1,000° C. Such processes contribute 2% of greenhouse gas emissions. Furthermore, food waste is estimated to cause around 10% of greenhouse gas emissions as a result of production, packaging and post-processing. Hence, reducing, recycling and reusing construction and food waste can considerably diminish the emission of greenhouse gases. If carbon sequestration by consuming CO₂ can be incorporated into the recycling of this waste, atmospheric greenhouse gases can be further reduced to promote carbon neutrality.

Currently, construction waste has been partially reused as aggregates to produce new concrete. However, as this process requires extra unreacted cement that causes secondary emissions of greenhouse gases, it is of no benefit to carbon sequestration. At the same time, replacing a portion of the raw materials with only construction waste during concrete production cannot reduce food waste, the other major MSW. Apart from the recycling and reusing of construction waste, some researchers have proposed the curing of concrete under elevated CO₂ concentrations to allow the concrete to absorb CO₂ as compensation for the carbon emitted during cement production. To react with a fresh concrete mixture, CO₂ normally needs to dissolve in the water of the mixture. However, the hardening of concrete is based on the hydration of cement, which reduces the available water in the mixture. Therefore, the dissolution of CO₂ in concrete is not efficient, leading to insignificant carbon sequestration during the curing process. In fact, the net CO₂ benefits of this method are more likely to be negative and may also decrease the compressive strength of the concrete.

In recent years, microbially induced calcite precipitation (MICP) has been proposed as a bioremediation process to bind and strengthen porous materials such as soil. Bacteria, urea and calcium salts are exogenously added to the porous material during this process. The bacteria decompose urea to produce carbonate ions, which then react with calcium ions provided by calcium salts, forming calcium carbonate to bind the porous material. However, it is known that the decomposition of urea generates ammonia, which dissolves in pore fluid and increases the pH of the material. A high pH can hinder or even terminate the bacterial activity and limit the efficiency of MICP. More importantly, the calcium carbonate formed may be eroded by acid rain while carbon sequestration is not achieved, as CO₂ is not a reactant in MICP.

In effect, no method of producing sustainable construction materials has yet been demonstrated that not only recycles and reuses both construction and food waste, but also sequesters CO₂ in the waste mixture.

### SUMMARY

A sustainable method of producing construction materials reusing construction and food waste and sequestering CO₂ in the waste mixture is provided. Construction waste can be mixed with food waste comprising calcium. The waste mixture is cured in an environment with a CO₂ supply, which reacts with the calcium present in the food waste thereby forming calcium carbonate, which reinforces the newly formed construction material.

This methodology not only converts both construction and food waste into economically viable products for various engineering applications but also sequesters CO₂ in the products to achieve carbon neutrality. The methods described herein do not require the use of cement, which provides further environmental benefits.

In a first aspect, the present disclosure provides a method for preparing a sustainable construction material, the method comprising: combining construction waste, food waste comprising calcium, and water thereby forming a waste mixture; optionally moulding the waste mixture; and contacting the waste mixture with CO₂ under conditions in which at least a portion of the calcium present in the waste mixture is converted to calcium carbonate thereby forming a treated waste mixture thereby forming the sustainable construction material.

In certain embodiments, the construction waste comprises concrete, bitumen, construction debris, crushed stone, concrete rubble, soil, aggregate, or a mixture thereof.

In certain embodiments, the food waste comprises eggshells, shellfish, bones, fish scales, or mixtures thereof.

In certain embodiments, the construction waste and the food waste are combined in a mass ratio of 1:1 to 97:3, respectively.

In certain embodiments, the waste mixture comprises water at a concentration of 5-80% m/m relative to the total weight of the construction waste, the food waste comprising calcium, and water.

In certain embodiments, the food waste comprises pyrolyzed food waste.

In certain embodiments, the method further comprises the step of applying a surface treatment to at least one surface of the sustainable construction material, wherein the surface treatment comprises a water repellent coating, a radiative cooling paint or a mixture thereof.

In certain embodiments, the water repellent coating comprises a silicone, a silane, a siloxane, a siliconate; and the radiative cooling paint comprises titanium oxide, barium sulphate, and a polyvinylidene fluoride-hexafluoropropylene copolymer.

In certain embodiments, the water repellent coating comprises silicone and a metal oxide.

In certain embodiments, the metal oxide is selected from the group consisting of magnesium oxide, aluminium oxide, titanium oxide and silicon oxide.

In certain embodiments, the metal oxide and the silicone are present at a mass ratio of 5:95 to 1:1, respectively.

In certain embodiments, the step of contacting the waste mixture with CO₂ comprises contacting the waste mixture with CO₂ at a pressure of 200-700 kPa.

In certain embodiments, the step of contacting the waste mixture with CO₂ is conducted for 3-30 days.

In certain embodiments, the method comprises: combining construction waste selected from the group consisting of construction debris, crushed rock, stone, concrete rubble, soil, and a mixture thereof; food waste comprising calcium selected from the group consisting of pyrolyzed eggshells, pyrolyzed shellfish, pyrolyzed bones, pyrolyzed fish scales, and mixtures thereof; and water thereby forming a waste mixture, wherein the construction waste; the food waste; and the water are present in the waste mixture at a mass ratio of 85:15:5 to 97:3:18, respectively; moulding the waste mixture; contacting the waste mixture with CO₂ at a pressure of 400-600 kPa under conditions in which at least a portion of the calcium present in the waste mixture is converted to calcium carbonate thereby forming a treated waste mixture; and optionally applying a surface treatment to a surface of the treated waste mixture thereby forming the sustainable construction material.

In certain embodiments, the construction waste; the food waste; and the water are present in the waste mixture at a mass ratio of 85:15:5 to 95:5:10, respectively.

In certain embodiments, the food waste comprises pyrolyzed eggshells, pyrolyzed bones, or a mixture thereof.

In certain embodiments, the step of contacting the waste mixture with CO₂ is conducted for 21-30 days.

In a second aspect, the present disclosure provides a sustainable construction material prepared according to the method described herein.

### BRIEF DESCRIPTION OF THE DRAWINGS

The above and other objects and features of the present disclosure will become apparent from the following description of the disclosure, when taken in conjunction with the accompanying drawings.

FIG. 1 shows the unconfined compressive strength of construction waste mixed with deionized water and a calcium chloride solution after curing under elevated CO₂ concentration for 7 days. Note: The strength is reported as average±standard error, n=3.

FIG. 2 indicates that the unconfined compressive strength of construction waste added with two types of food waste after 28 days of curing with CO₂. Note: The value is given as average±standard error, n=3.

FIG. 3 shows the unconfined compressive strength of construction waste mixed with eggshell biochar and bone biochar at different concentrations after 28 days of curing under elevated CO₂. Note: The value is reported as average±standard error, n=3; low′ and ‘High’ indicate low and high sample density, respectively.

### DETAILED DESCRIPTION

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

As objective of the present disclosure is to provide a method for preparing sustainable construction materials from mixtures of construction and food waste and involving the formation of calcium carbonate by providing a mixture of construction and food waste with CO₂.

In certain embodiments, air-dried or oven-dried construction and food waste can first be crushed to reduce particle size and increase the surface area to improve reaction rates. The crushed and sieved waste can then be mixed at the desired mass ratio of construction waste and food waste. Water can then be added to moisten the mixture and assist with CO₂ dissolution. The waste mixture can optionally be moulded into different shapes to suit various engineering application requirements. Next, the optionally moulded material can be placed and cured in an environment with high CO₂ concentration. During curing, carbonate ions generated in situ react with the calcium ions in the food waste to form calcium carbonate, which strengthens the optionally moulded mixture. To prevent erosion of the calcium carbonate due to acid rain and extend the service life, silicone or silicate can be sprayed onto the cured material to form a hydrophobic layer. This will facilitate the flow of rainwater away from the material surface to minimise water infiltration and avoid erosion of the material. A silicone layer can also facilitate radiative cooling, passively reducing the surrounding temperature. The efficiency of radiative cooling through the silicone layer can be improved by mixing metal oxides into the silicone or by first applying radiative cooling paint to the cured material prior to spraying the silicone layer. This sustainable construction material produced from food and construction waste via carbon sequestration can be applied in various types of construction work such as retaining walls, partition walls and road pavements.

In certain embodiments, construction waste refers to any unwanted materials produced during construction work, including but not limited to the construction and demolition of buildings, ground levelling and road paving. In certain embodiments, the construction waste is substantially inert construction waste, including but not limited to concrete, bitumen, asphalt, construction debris, rubble, rock, soil and/or aggregate.

In certain embodiments, food waste refers to any food residuals produced during food processing or leftovers that comprise calcium. Such food waste can either be mixed directly with construction waste or first pyrolyzed to form biochar before being mixed with construction waste.

In certain embodiments, the mixing ratio of the construction and food waste should not exceed 1:1 by mass to ensure that the sustainable material consists mainly of construction waste, which generally has a higher strength.

In certain embodiments, the amount of water added to the waste mixture should result in a mixture saturation of between 10% and 80% to ensure that there is adequate water to dissolve CO₂ such that the dissolved CO₂ is distributed evenly to form carbonate ions in the moist waste mixture.

In certain embodiments, the moulded waste mixture can be placed in any space that allows it to be exposed to CO₂. This environment should preferably be a confined space to reduce the leakage and consumption of CO₂.

In certain embodiments, the CO₂ concentration that is applied to an environment for curing the moulded waste mixture can be at any arbitrary levels. Preferably, a confined space with CO₂ at 500 kPa should be provided to accelerate the dissolution of CO₂ in the moulded waste mixture. There is no specific requirement for the curing duration. The moulded waste mixture should preferably be cured for 7 to 28 days.

In certain embodiments, the hydrophobic layer can be formed with silicone or silicates including but not limited to polydimethylsiloxane, dichlorodimethylsilane, potassium silicate, potassium methyl silicate and potassium methylsilanetriolate. Preferably, silicone should be used as the hydrophobic layer to achieve a passive cooling effect simultaneously.

In certain embodiments, the passive cooling effect of the silicone layer can be enhanced by adding metal oxides, including but not limited to magnesium oxide, aluminium oxide, titanium oxide and silicon oxide, into the silicone. The mass ratio of metal oxides to silicone should not exceed 50% and should preferably be 5%. Alternatively, the passive cooling effect of the silicone layer can be enhanced by first applying a layer of radiative cooling white paint onto the cured waste mixture. Silicone can then be sprayed on top of the paint. The white paint should consist of chemicals including but not limited to titanium oxide, barium sulphate and polyvinylidene fluoride-hexafluoropropylene copolymer.

The methods described herein provides a number of advantages, such as: (1) recycles construction and food waste while turning the waste into a sustainable construction material that has economic value; (2) takes advantage of carbon sequestration to store CO₂ in construction and food waste, which is unique and can reduce carbon emissions compared with existing alternatives; (3) provides an increased service life and functionality of the sustainable construction material resulting from the hydrophobic layer, which can minimise the infiltration of acid rain and prevent the erosion of the calcium carbonate formed therein; and also provide radiative cooling; and (4) reduces reliance on traditional construction materials resulting in greater reductions in CO₂ production.

Provided herein is a method for preparing a sustainable construction material, the method comprising: combining construction waste, food waste comprising calcium, and water thereby forming a waste mixture; optionally moulding the waste mixture; contacting the waste mixture with CO₂ under conditions in which at least a portion of the calcium present in the waste mixture is converted to calcium carbonate thereby forming the sustainable construction material.

The construction waste can comprise any substantially inert construction waste including but not limited to concrete, bitumen, asphalt, construction debris, concrete rubble, rock, stone, soil, aggregates, or a mixture thereof.

The aggregates can be coarse aggregates, fine aggregates, or a mixture thereof.

The coarse aggregates can be coarse gravel, medium gravel, fine gravel, crushed rock, pebbles, stones, concrete rubble, river gravel, sea gravel, crushed glass, slate waste, waste plastics, recycled coarse aggregate derived from demolition waste and combinations thereof.

The terms “fine aggregates” and “coarse aggregates” used herein are not intended to limit a range of sizes but are simply used to indicate that one type of aggregate contains larger particles than the other type. For example, in a cement mixture containing two types of fine sand, the fine sand with larger particles will be called coarse aggregate.

The construction waste can optionally be dried to remove any residual moisture prior to use in the methods described herein. In certain embodiments, the construction waste is air-dried or dried at a temperature between 60-150° C., 80-150° C., 80-130° C., 80-110° C., 90-110° C., or about 100° C.

The particle size of the construction waste can optionally be reduced prior to use in the methods described herein. Advantageously, construction waste with reduced particle size and increased surface improves the rate of reaction with CaCO₃. In certain embodiments, the particle size of the construction waste is first reduced and then passed through a sieve, such as a 7-mm, 6-mm, 5-mm, 4-mm, 3-mm, 2-mm, or 1-mm sieve, to improve the homogeneity of the construction waste particles.

There are various known methods for controlling the particle size of a material, including reduction by comminution or de-agglomeration by milling and/or sieving. Exemplary methods for particle reduction include, but are not limited to jet milling, hammer milling, compression milling and tumble milling processes (e.g., ball milling).

The food waste can be any food waste that comprises calcium. The food waste can be but not limited to industrial, commercial, agricultural, livestock, meatpacking/slaughterhouse, dairy, fisheries, and/or consumer food waste. Exemplary food waste includes, but is not limited to dairy products (milk and milk products, such as cheese), vegetables (such as collard greens, spinach, bok choy, kale, broccoli, etc.), nuts/seeds, eggshells, seashells (such as shells of cockle, mussel, oysters, clams, scallops, limpets, etc), crustacean shells (such as shrimp, crabs, lobster, fish scales, crayfish, hill, etc), bones (such as bones from cows, buffalo, horses, pigs, ducks, chicken, goats, sheep, cuttlefish, etc), and combinations thereof. In certain embodiments, the food waste comprises eggshells, bones, or a mixture thereof.

In certain embodiments, the food waste is pyrolyzed to form biochar prior to use in the methods described herein. Accordingly, in certain embodiments, the food waste comprises biochar. In certain embodiments, the food waste comprises eggshell biochar, bone biochar, or a mixture thereof.

The food waste can be pyrolyzed at a temperature between 200-700° C., 200-600° C., 200-500° C., 200-400° C., 250-350° C., or 275-325° C. In certain embodiments, the food waste is pyrolyzed at a temperature of about 300° C.

The waste mixture can comprise the construction waste and the food waste at a mass ratio of 1:1 to 99:1, 1:1 to 98:2, 1:1 to 97:3, 1:1 to 96:4, 1:1 to 95:5, 1:1 to 90:10, 1:1 to 85:15, 1:1 to 80:20, 3:2 to 97:3, 7:3 to 97:3, 4:1 to 97:3, 9:1 to 97:3, or 9:1 to respectively. In certain embodiments, the waste mixture comprises the construction waste and the food waste at a mass ratio of about 95:5 to about 90:10.

The waste mixture can optionally be moulded by using a moulding having the desired shape. The moulded waste mixture can take any shape that can be formed with a mould, including but not limited to spherical, cubical, cuboid, cylindrical, conical, pyramidal, sheets, tubes, and the like.

The step of contacting the waste mixture with CO₂ can comprise bringing the waste mixture into contact with CO₂ in gaseous, liquid, or super critical form. In certain embodiments, the step of contacting the waste mixture with CO₂ comprises contacting the waste mixture with an atmosphere of CO₂ at 1-6,000 kPa, 10-6,000 kPa, 50-6,000 kPa, 100-6,000 kPa, 100-5,500 kPa, 100-5,000 kPa, 100-4,500 kPa, 100-4,000 kPa, 100-3,500 kPa, 100-3,000 kPa, 100-2,500 kPa, 100-2,000 kPa, 100-1,500 kPa, 100-1,000 kPa, 100-900 kPa, 100-800 kPa, 100-700 kPa, 100-600 kPa, 100-500 kPa, 100-400 kPa, 100-300 kPa, 100-200 kPa, 200-900 kPa, 300-900 kPa, 300-800 kPa, 300-700 kPa, 300-600 kPa, 400-600 kPa, 300-700 kPa, 200-600 kPa, or 450-550 kPa. In certain embodiments, the step of contacting the waste mixture with CO₂ comprises contacting the waste mixture with an atmosphere of CO₂ at about 500 kPa.

The step of contacting the waste mixture with CO₂ comprises contacting the waste mixture with an atmosphere of CO₂ at 20-100° C., 20-90° C., 20-80° C., 20-70° C., 20-60° C., 20-50° C., 20-40° C., 20-30° C., or 20-25° C. In certain embodiments, step of contacting the waste mixture with CO₂ comprises contacting the waste mixture with an atmosphere of CO₂ at about 23° C.

Depending on the conditions employed, the step of contacting the waste mixture with CO₂ can be conducted from 1-45 days, 1-40 days, 1-35 days, 7-35 days, 7-30 days, 7-28 days, 7-21 days, 7-14 days, 14-28 days, 21-28 days, 21-35 days, 23-33 days, 24-32 days, 25-31 days, 26-30 days, or 27-29 days. In certain embodiments, the step of contacting the waste mixture with CO₂ can be conducted for about 28 days.

One or more of the surfaces of the sustainable construction material can optionally be treated to improve the water repellence, durability, and/or the solar absorptivity of the sustainable construction material.

In certain embodiments, a surface treatment is applied to at least one surface of the sustainable construction material. The surface treatment can comprise a water repellent coating, a radiative cooling paint or a mixture thereof.

The water repellent coating can be any water repellent coating known to those skilled in the art. In certain embodiments, the water repellent coating comprises a silicone, such as a polyalkylsiloxane or a polydimethylsiloxane; a silane, such as dichlorodimethylsilane; a siliconate, such as potassium methylsilanetriolate; or a silicate, such as sodium silicate, potassium silicate, sodium silicate, potassium methyl silicate, or the like.

The radiative cooling paint can be any radiating cooling paint known to those skilled in the art. In certain embodiments, the radiative cooling paint comprises silicone and a metal oxide. The metal oxide can be selected from the group consisting of magnesium oxide, aluminium oxide, titanium oxide and silicon oxide. In certain embodiments, the radiative cooling paint comprises titanium oxide, barium sulphate, and a polyvinylidene fluoride-hexafluoropropylene copolymer.

The present disclosure also provides a sustainable construction material prepared in accordance with the methods described herein. The sustainable construction material can be used in retaining walls, partition walls, and road pavement.

### EXAMPLES

### Example 1—Strength of Construction Waste with Calcium Solution and CO₂

Construction waste, which comprises construction debris, crushed rock, stone, concrete rubbles and soil, is first oven dried at 100° C. for 24 hours to remove moisture. It is then passed through a 2-mm sieve to ensure the homogeneity of the test samples. Calcium chloride is then dissolved in deionised water to prepare a calcium solution at 5 mol/L. The calcium solution is then used as an analogue for food waste containing calcium. The sieved construction waste is then mixed thoroughly with the calcium solution.

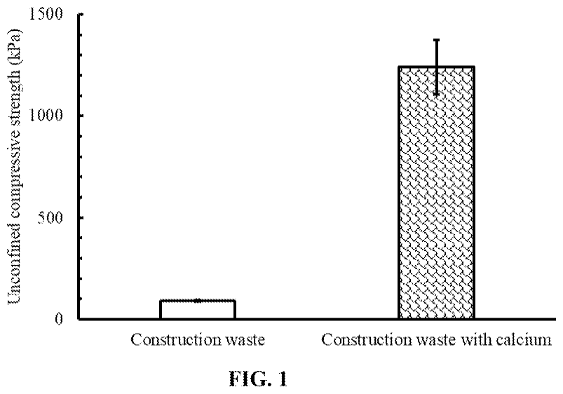

For the control experiment, the sieved construction waste is mixed thoroughly with deionized water. The mixture is compacted into a cylindrical sample with a diameter and height of 70 mm inside an acrylic mould. The dry density and degree of saturation of the sample are 1,410 kg/m 3 and 57%, respectively. After compaction, the acrylic mould can be sealed and supplied with CO₂ at 500 kPa to cure the waste mixture under an elevated CO₂ concentration. Next, the waste mixture can be cured for 7 days and then oven dried at 100° C. for 24 hours. Thereafter, an unconfined compression test can be conducted with a loading device at a shearing rate of, e.g., 1 mm/min. A proving ring and digital dial gauge are installed to measure compressive stress and axial strain, respectively, during the test. The measured maximum compressive stress is considered to represent the unconfined compressive strength of the sample. Three replicates are prepared for each test condition (i.e., the sample mixed with calcium solution and the sample mixed with deionized water) to ensure repeatability. The unconfined compressive strength of each test condition is shown in FIG. 1. The reported value is the average of the three replicates with error bars included. The unconfined compressive strength of construction waste mixed with deionized water is 90 kPa, while that of construction waste mixed with the calcium solution is increased to 1,250 kPa after curing under elevated CO₂ concentration. The 13-fold increase in compressive strength is caused by the formation of calcium carbonate during curing under elevated CO₂ concentration. These test results demonstrate conceptually that mixing food waste containing calcium with construction waste can consume CO₂ to form calcium carbonate, which strengthens the construction waste and converts municipal solid waste into a sustainable construction material via carbon sequestration.

### Example 2—Strength of Construction Waste Added with Food Waste and CO₂ Curing

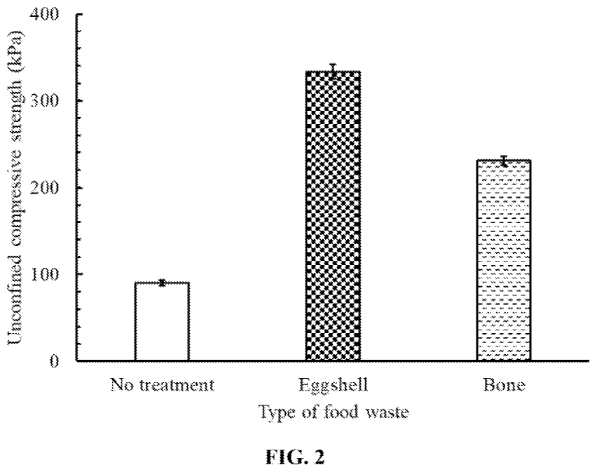

Construction waste that included construction debris, crushed rock, stone, concrete rubbles and soil, passing through a 2-mm sieve is used in this example embodiment. Two types of food waste, eggshell and bone, are collected and crushed to powder with a particle size smaller than 2 mm. The construction waste is added with the food waste at a mass ratio of 20% (w/w) and then mixed thoroughly with deionized water. The gravimetric water content of the mixture is 19%. The mixture is compacted inside an acrylic mould to produce a cylindrical sample with a diameter and height of mm. The dry density of samples is 1,410 kg/m 3. All samples are placed in a pressure chamber supplied with CO₂ at 500 kPa and cured for 28 days. After curing, the samples are oven dried at 100° C. for 24 hours. Unconfined compression test is conducted to shear the samples at 1 mm/min. The compressive stress and axial displacement of the samples are obtained by a load cell and a linear variable differential transformer, respectively. Each test condition is repeated three times. FIG. 2 shows the unconfined compressive strength of construction waste mixed with two types of food waste (i.e., eggshell and bone). The presence of eggshell and bone always reinforce construction waste. Compared with the control without food waste, the strength of construction waste mixed with eggshell and bone is increased by 1.5 and 2.7 times, respectively. Such results prove that adding any types of food waste containing calcium reinforces construction waste by capturing CO₂ to form calcium carbonate. The invented technology not only helps to turn construction waste and food waste into sustainable construction materials, but also provides a solution to capture CO₂ for carbon neutrality.

### Example 3—Strength of Construction Waste Comprising Food Waste Derived Biochar after Curing with CO₂

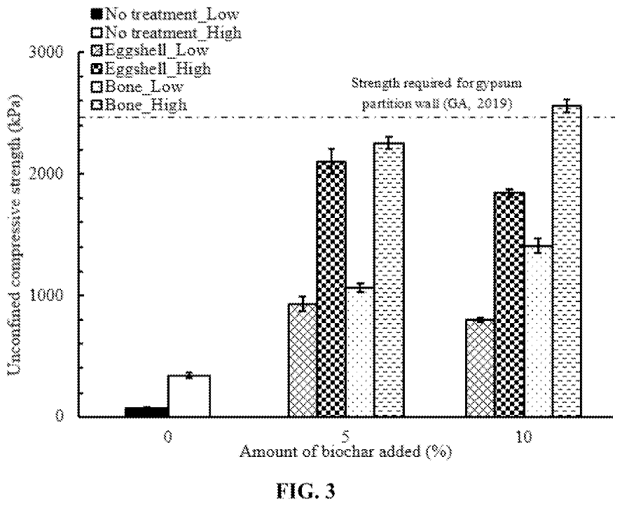

Construction waste that included construction debris, crushed rock, stone, concrete rubbles and soil, sieved through a 2-mm sieve is adopted in this example embodiment. Waste of eggshell and bone is collected and pyrolyzed at 300° C. for 2 hours to produce biochar. The biochar is then crushed to powder using a grinder. To prepare testing samples, the sieved construction waste is mixed thoroughly with biochar at different mass ratios. Eggshell biochar and bone biochar are adopted while the amount of biochar added includes 5% and 10% (w/w). Deionized water is also added to the mixture to achieve 5% gravimetric water content. The mixture is compacted into a cylindrical sample with diameter of 50 mm and height of 100 mm. Low and high density of samples, which correspond to 1,782±17 kg/m 3 and 1,901±18 kg/m 3, are considered. After compaction, the samples are put in a pressure chamber supplied with CO₂ at 500 kPa for curing. The samples are cured for 28 days and then oven dried at 100° C. for 24 hours. Unconfined compression tests are carried out to determine the strength of the samples. The samples are sheared at a rate of 1 mm/min. During shearing, the compressive stress and axial displacement of the samples are measured using a load cell and a linear variable differential transformer, respectively. For each test condition, there are three replicates. The unconfined compressive strength of each condition is summarized in FIG. 3. Compared with construction waste without treatment, the strength of biochar amended construction waste at any densities and biochar concentrations are always improved. In general, the strength of construction waste with food waste-derived biochar increases with an increasing amount of biochar added and sample density. The strength of the amended construction waste at low and high density is increased by at least 12 times and 5 times, respectively. The maximum improved strength is up to around 2.6 MPa, which is higher than the typical strength (i.e., 2.4 MPa) required for regular gypsum partition wall (GA, 2019). These results confirm that the new eco-friendly materials produced only using wastes and CO₂ is feasible to be adopted in construction, such as non-structural applications including partition walls.

It is understood that many additional changes in the details, materials, and steps herein described and illustrated to explain the nature of the subject matter may be applied by those skilled in the art within the principle and scope of this invention as expressed in the appended claims.

What is claimed is:

1. A method for preparing a sustainable construction material, the method comprising:
combining construction waste, food waste comprising calcium, and water thereby forming a waste mixture;
optionally moulding the waste mixture; and
contacting the waste mixture with CO₂ under conditions in which at least a portion of the calcium present in the waste mixture is converted to calcium carbonate thereby forming a treated waste mixture thereby forming the sustainable construction material.

2. The method of claim 1, wherein the construction waste comprises concrete, bitumen, construction debris, crushed stone, concrete rubble, soil, aggregate, or a mixture thereof.

3. The method of claim 1, wherein the food waste comprises eggshells, shellfish, bones, fish scales, or mixtures thereof.

4. The method of claim 1, wherein the construction waste and the food waste are combined in a mass ratio of 1:1 to 97:3, respectively.

5. The method of claim 1, wherein the waste mixture comprises water at a concentration of 5-80% m/m relative to the total weight of the construction waste, the food waste comprising calcium, and water.

6. The method of claim 1, wherein the food waste comprises pyrolyzed food waste.

7. The method of claim 1 further comprising the step of applying a surface treatment to at least one surface of the sustainable construction material, wherein the surface treatment comprises a water repellent coating, a radiative cooling paint or a mixture thereof.

8. The method of claim 7, wherein the water repellent coating comprises a silicone, a silane, a siloxane, a siliconate; and the radiative cooling paint comprises titanium oxide, barium sulphate, and a polyvinylidene fluoride-hexafluoropropylene copolymer.

9. The method of claim 7, wherein the water repellent coating comprises silicone and a metal oxide.

10. The method of claim 9, wherein the metal oxide is selected from the group consisting of magnesium oxide, aluminium oxide, titanium oxide and silicon oxide.

11. The method of claim 9, wherein the metal oxide and the silicone are present at a mass ratio of 5:95 to 1:1, respectively.

12. The method of claim 1, wherein the step of contacting the waste mixture with CO₂ comprises contacting the waste mixture with CO₂ at a pressure of 200-700 kPa.

13. The method of claim 12, wherein the step of contacting the waste mixture with CO₂ is conducted for 3-30 days.

14. The method of claim 1, wherein the method comprises:
combining construction waste selected from the group consisting of construction debris, crushed rock, stone, concrete rubble, soil, and a mixture thereof; food waste comprising calcium selected from the group consisting of pyrolyzed eggshells, pyrolyzed shellfish, pyrolyzed bones, pyrolyzed fish scales, and mixtures thereof; and water thereby forming a waste mixture, wherein the construction waste; the food waste; and the water are present in the waste mixture at a mass ratio of 85:15:5 to 97:3:18, respectively;
moulding the waste mixture;
contacting the waste mixture with CO₂ at a pressure of 400-600 kPa under conditions in which at least a portion of the calcium present in the waste mixture is converted to calcium carbonate thereby forming a treated waste mixture; and
optionally applying a surface treatment to a surface of the treated waste mixture thereby forming the sustainable construction material.

15. The method of claim 14, wherein the construction waste; the food waste; and the water are present in the waste mixture at a mass ratio of 85:15:5 to 95:5:10, respectively.

16. The method of claim 15, wherein the food waste comprises pyrolyzed eggshells, pyrolyzed bones, or a mixture thereof.

17. The method of claim 14, wherein the step of contacting the waste mixture with CO₂ is conducted for 21-30 days.

18. The method of claim 16, wherein the step of contacting the waste mixture with CO₂ is conducted for 21-30 days.

19. A sustainable construction material prepared according to the method of claim 1.

20. A sustainable construction material prepared according to the method of claim 18.
